(19) United States
(12) Patent Application Publication
(10) Pub. No.: US 2018/0353362 A1
(43) Pub. Date: Dec. 13, 2018

(54) SUBJECT SUPPORT APPARATUSES

(71) Applicant: Liko Research & Development AB, Lulea (SE)

(72) Inventor: Elin Dovervik, Luleå (SE)

(73) Assignee: Liko Research & Development AB, Lulea (SE)

(21) Appl. No.: 15/991,121

(22) Filed: May 29, 2018

Related U.S. Application Data
(60) Provisional application No. 62/517,462, filed on Jun. 9, 2017.

(51) Int. Cl. A61G 7/10

(52) U.S. Cl. CPC A61G 7/1051; A61G 7/1023; A61G 7/1078; A61G 2200/34; A61G 7/1017

(57) ABSTRACT

A sling including a body support substrate having a subject support surface on a first side of the body support substrate and an outer surface on a second side of the body support substrate opposite the first side. The subject support surface and the outer surface are separated by a thickness t of the body support substrate. The body support substrate is formed from a cellulose-based, or paper, material. Methods of lifting a subject using the sling are also disclosed.

### CROSS-REFERENCE TO RELATED APPLICATIONS

The present application claims priority to U.S. Provisional Patent Application Ser. No. 62/517,462, filed Jun. 9, 2017, and entitled “Subject Support Apparatuses,” the entirety of which is incorporated by reference herein.

### BACKGROUND

### Field

The present specification generally relates to subject support apparatuses, and more particularly to disposable subject support apparatuses.

### Technical Background

Person lifting devices, such as mobile lifts and/or overhead lifts, may be used in hospitals, other health care facilities, and sometimes in home care settings to move a subject or assist in moving a subject from one location to another. Conventional lifting devices are coupled to a subject support apparatus that supports and engages the subject. Such conventional support apparatuses are either re-used between subjects, or may be disposable. However, typical disposable subject support apparatuses may be costly to manufacture and may be made from materials that are damaging to the environment. For example, disposable subject support apparatus are conventionally made from materials that are not recyclable or biodegradable, and/or are manufactured from non-renewable resources.

Accordingly, a need exists for alternative subject support apparatuses that are disposable and made from environmentally-friendly materials.

### SUMMARY

In one embodiment, a sling includes a body support substrate having a subject support surface on a first side of the body support substrate and an outer surface on a second side of the body support substrate opposite the first side. The subject support surface and the outer surface are separated by a thickness t of the body support substrate. The body support substrate is formed from a cellulose-based material, such as a paper material.

In another embodiment, a sling includes a body support substrate and at least two support loops coupled to the sling. The body support substrate has a subject support surface on a first side of the body support substrate and an outer surface on a second side of the body support substrate opposite the first side. The subject support surface and the outer surface are separated by a thickness t of the body support substrate. The body support substrate is made of a cellulose-based material, such as a paper material.

In yet another embodiment, a method of lifting a subject is provided. The method includes positioning a sling between the subject and a surface upon which the subject is disposed, coupling the sling to a lift mechanism, and activating the lift mechanism to lift the subject. The sling is formed from a body support substrate having a subject support surface on a first side of the body support substrate and an outer surface on a second side of the body support substrate opposite the first side. The subject support surface and the outer surface are separated by a thickness t of the body support substrate. The body support substrate is made of a cellulose-based material, such as a paper material.

Additional features of subject support apparatuses described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a side perspective view of a subject support apparatus coupled to a lift system and supporting a subject according to one or more embodiments shown and described herein;

FIG. 2A schematically depicts a bottom view of the subject support apparatus of FIG. 1 according to one or more embodiments shown and described herein;

FIG. 2B schematically depicts a bottom view of an alternative embodiment of a subject support apparatus according to one or more embodiments shown and described herein;

FIG. 3A schematically depicts a cross-section of a body support substrate having a substantially constant thickness t according to one or more embodiments shown and described herein;

FIG. 3B schematically depicts a cross-section of a body support substrate having a thickness that varies according to one or more embodiments shown and described herein;

FIG. 4 schematically depicts a sling bar for use with the subject support apparatus according to one or more embodiments shown and described herein; and

FIG. 5 schematically depicts a lift mechanism for use with the subject support apparatus according to one or more embodiments shown and described herein.

### DETAILED DESCRIPTION

Reference will now be made in detail to embodiments of subject support apparatuses, examples of which are illustrated in the accompanying drawings. Whenever possible, the same reference numerals will be used throughout the drawings to refer to the same or like parts. In one embodiment, a subject support apparatus includes a body support substrate having a subject support surface on a first side of the substrate and an outer surface on a second side of the substrate opposite the first side. The subject support surface and the outer surface are separated by a thickness t of the body support substrate, which is made from a cellulose-based material, such as a paper material. Without being bound by theory, the use of a subject support apparatus that includes a body support apparatus made from cellulose-based material, such as a paper material, may enable the subject support apparatus to be disposed after each use, thereby reducing or even elimination the potential for transfer or bacteria or viruses from one subject to another subject, while being recyclable and biodegradable. Various embodiments of subject support apparatuses will be described herein with specific reference to the appended drawings.

### Subject Support Apparatuses

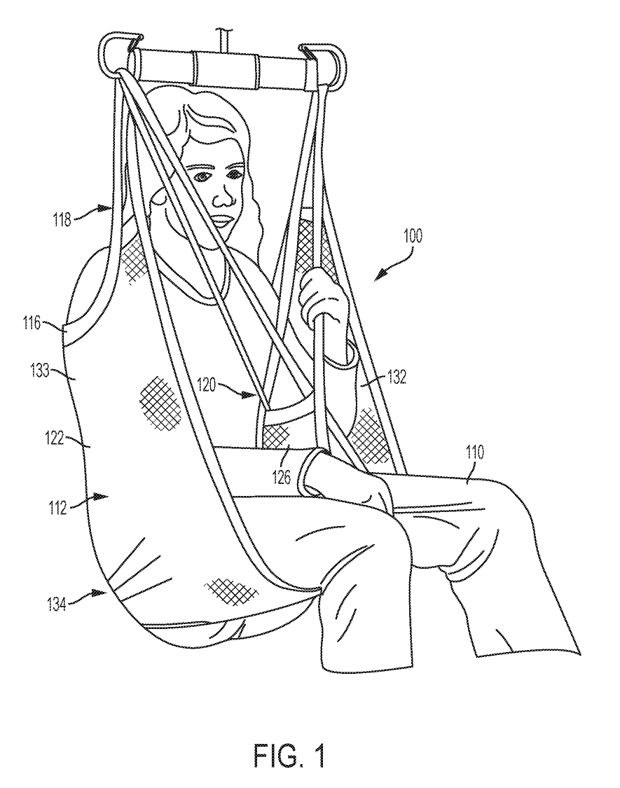

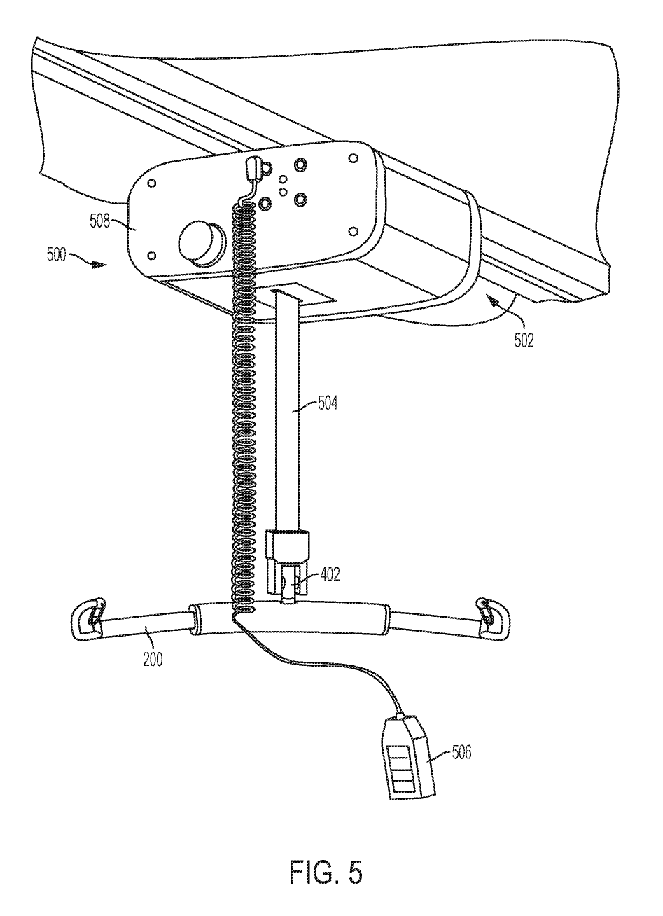

Referring to FIG. 1, a subject 10 is positioned in a subject support apparatus 100. The subject support apparatus 100 is shown as a support sling 112 or harness that is configured to be coupled to a sling coupling portion of a subject lifting device, or lift mechanism 500 (FIG. 5), as will be described in greater detail below. In various embodiments, the subject support apparatus 100 is a disposable support sling, although in other embodiments, the subject support apparatus 100 may be a disposable lift sheet, lift strap, wrap, head support vest, or other subject support apparatus, such as those commercially available from Liko, HILL-ROM®, or Hill-Rom Services, Inc. (Batesville, Ind.).

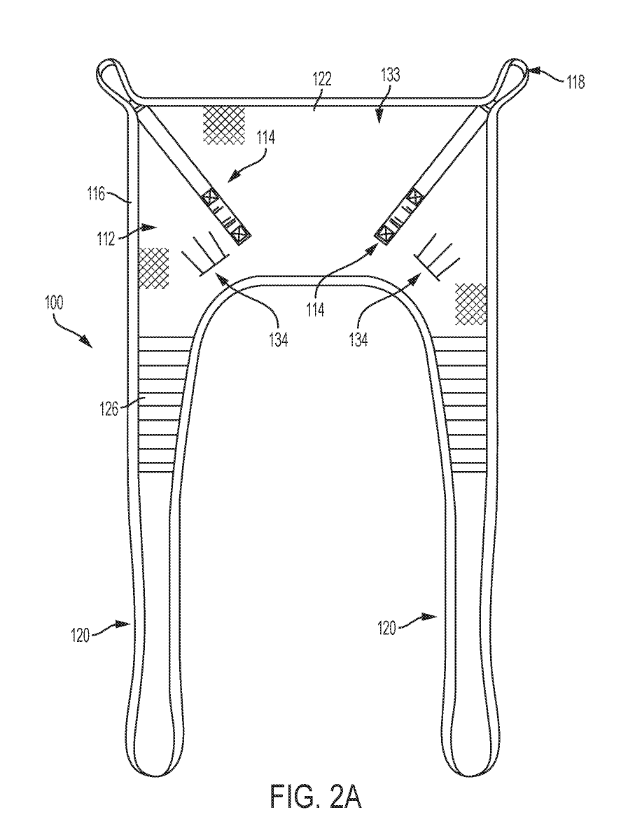

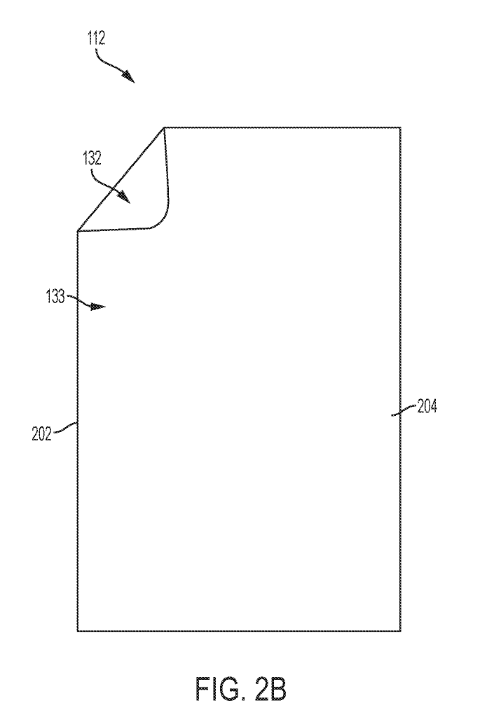

In various embodiments, the sling 112 may further include handles 114, a binding 116, upper loops 118, and leg support loops 120, which may be attached to the sling 112 using staples, stitches, an adhesive, or another attachment mechanism, as will be described below. The sling 112 includes a back support portion 122 and leg support portions 126 extending from the back support portion 122 as shown in FIG. 2A. The back support portion 122 is configured to support the subject's back, including a back portion of the buttocks, and the leg support portions 126 are configured to engage and support the subject's thighs.

Although depicted in FIGS. 1 and 2A as having a shape contoured to support the subject 10, it is contemplated that in other embodiments, the sling 112 may be in the form of a sheet (e.g., substantially rectangular), such as is shown in FIG. 2B. As shown in FIG. 2B, the sling 112 is in the form of a sheet having an outer perimeter 202 that extends around and defines a support region 204 of the sling 112. In the embodiments shown in FIGS. 2A and 2B, the sling 112 is substantially planar (e.g., flat), although in other embodiments, the sling 112 may be constructed with contours in multiple dimensions, such as contours which correspond to the human body. For example, the sling 112 may include pleats 134, darts, or other structural features that enable the sling 112 to conform to the contours of a subject's body. Pleats, darts, folds, and other structural features may be particularly advantageous in areas of the sling 112 that support or surround the shoulders, hips, and buttocks of the subject.

Other shapes are contemplated, and may vary depending on the particular configuration intended for the subject support apparatus 100. In various embodiments, the sling 112 may be a single, substantially continuous piece of flexible material, such as a sheet of a body support substrate 130 formed from a cellulose-based material, such as a paper material. The body support substrate 130 may be folded and gathered to form one or more pleats 134 (depicted in FIGS. 1 and 2A), which may be secured together at one or both ends of the pleat using an adhesive, stitching, staples, or the like. The pleat 134 may enable the body support substrate 130 to lay substantially planar, which may enable multiple slings to be easily stacked and packed or folded. Alternatively or additionally, the body support substrate 130 may be partially cut to form a wedge shape and the edges of the wedge shape may be pivoted and rejoined to form a dart in the body support substrate 130. The dart may form a shallow cone in the body support substrate 130.

The cellulose-based material may be a paper material may be, by way of example and not limitation, a cellulosic paper, construction paper, kraft paper, art paper, paper board, coated paper, or the like. The cellulose-based material may also be, for example, a material, such as a fabric or textile formed from cellulose fibers. In various embodiments, the sling 112 is free of nylon, polyester, cotton, or blends thereof, and other types of fabric and/or non-biodegradable materials. Accordingly, in various embodiments, the sling 112 consists of, or consists essentially of, a cellulose-based material or, in other embodiments, a paper material.

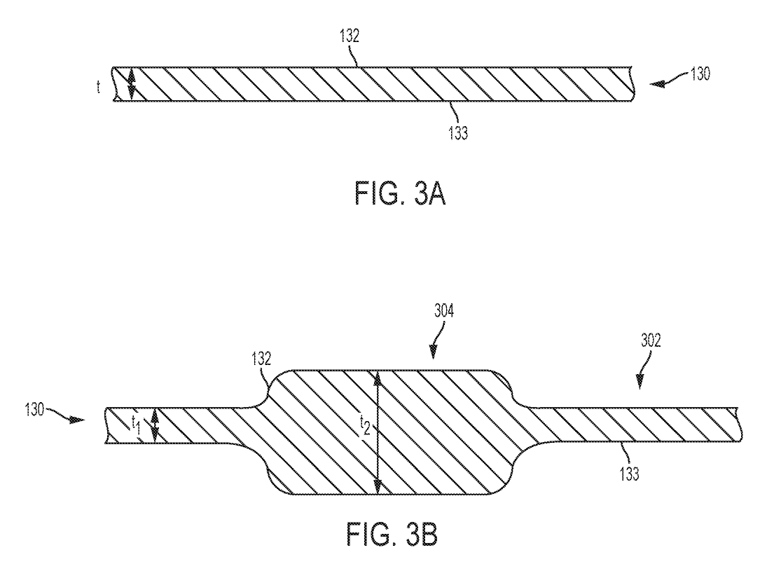

In various embodiments, the body support substrate 130 comprises a subject support surface 132 on a first side of the body support substrate 130 and an outer surface 133 on a second side of the body support substrate 130 opposite the first side, as shown in FIGS. 3A and 3B. The subject support surface 132 and the outer surface 133 are separated by a thickness t of the body support substrate 130. When in use, at least a portion of the subject support surface 132 is in contact with the subject 10 being supported while the outer surface 133 is exposed to the environment. Accordingly, in various embodiments, non-recyclable and/or non-biodegradable materials are not present to prevent decomposition of the body support substrate 130 after use.

In various embodiments, the body support substrate 130 may be formed from a single layer of cellulose-based material, although it is contemplated that in various embodiments, at least a portion of the body support substrate 130 includes multiple layers, or plies, of the cellulose-based material. For example, for subject support apparatuses 100 that are intended to be used with subjects weighing more, such as adult subjects, the body support substrate 130 may include multiple layers of cellulose-based material to provide sufficient strength to support the subject 10. However, subject support apparatuses 100 that are intended to be used with subjects weighing less, such as pediatric subjects, the body support substrate 130 may include fewer layers of cellulose-based material including, for example, only a single layer of cellulose-based material.

In various embodiments, the thickness t may be constant along a length and width of the body support substrate 130, as is depicted in FIG. 3A. However, it is contemplated that in some embodiments, the body support substrate 130 may include areas that have a greater thickness relative to other areas of the body support substrate 130. For example, in the embodiment shown in FIG. 3B, the body support substrate has a first area 302 having a first thickness, t₁, and a second area 304 having a second thickness, t₂. The first thickness, t₁, is less than the second thickness, t₂. In other words, in some embodiments, the thickness t may vary along a length and/or width of the body support substrate 130.

For example, an area of the body support substrate 130 corresponding to the leg support portions 126 may have a greater thickness than an area of the body support substrate 130 corresponding to a perimeter of the back support portion 122 which is not typically in contact with the subject. In other words, the first area 302 may correspond to the back support portion 122 and the second area 304 may correspond to the leg support portions 126. As another example, an area of the body support substrate 130 corresponding to an area of the back support portion 122 that supports the shoulders of the subject 10 may have a greater thickness than an area of the body support substrate 130 corresponding to an area of the back support portion 122 supporting the lower back of the subject 10. In other words, the first area 302 may correspond to an area of the back support portion 122 supporting the lower back of the subject 10 and the second area 304 may correspond to an area of the back support portion 122 supporting the shoulders of the subject 10. It is contemplated that other areas of the body support substrate 130 may be reinforced with additional layers of cellulose-based material in areas that provide greater support to the subject 10. Accordingly, the portions of the body support substrate 130 that have a greater thickness relative to other portions of the body support substrate 130 may vary depending on the particular embodiment, and in particular, based on the portions of the body support substrate 130 that provide greater support 10 to the subject during use.

In embodiments in which the body support substrate 130 includes more than one layer of cellulose-based material, various methods of forming the body support substrate 130 from the layers are contemplated. For example, the layers may be adhered to one another using an adhesive, crimping, or stitching, or the layers may be laminated to one another, such as by using a coating surrounding the layers of the body support substrate 130, as will be described in detail below.

According to various embodiments, the body support substrate 130 may be coated on one or both sides with a coating. The coating may be, for example, a thermoplastic polyurethane or polyurethane to make the substrate fluid impermeable. In various embodiments, the coating may be made from a biodegradable polymer to enable the subject support apparatus 100 to be biodegradable. As used here, the term “biodegradable” means a material that breaks down after fulfilling its intended purpose resulting in natural byproducts such as gases (CO₂, N₂), water, biomass, and inorganic salts.

Examples of biodegradable polymers include, by way of example and not limitation, any of the known classes of biodegradable polymers, and may be, for example, a polyurethane, a polystyrene, a polyamide, a polyester polymer (e.g., aliphatic polyester and/or aromatic polyester), lignin-based plastics, starch-based plastics, cellulose-based plastics, protein-based plastics, or bio-derived polyethylene. In some embodiments, the biodegradable polymer be, for example, polylactic acid (PLA), polymalate (PMA), polyhydroxyalkanoate (PHA), polyhydroxybutyrate (PHB), polycaprolactone (PCL), polyesteramide (PEA), polyhydroxyvalerate (PHV), polyhydroxyhexanoate (PHH), aliphatic copolyesters, polethylen furanoate (PEF), polybutylene succinate (PBS), polyglycolic acid, aliphatic polyaspartic, polyuria, soybase polymers, and mixtures and copolymers thereof.

Other coatings may be employed, depending on the particular embodiment, provided that they are able to reduce the absorption of fluid, including various bodily fluids such as blood, perspiration, and urine, into the body support substrate 130. Accordingly, the subject support surface 132 may be coated with a coating effective to make the body support substrate 130 fluid impermeable, the outer surface 133 may be coated with a coating effective to make the body support substrate 130 fluid impermeable, or both the subject support surface 132 and the outer surface 133 may be coated with a coating effective to make the body support substrate 130 fluid impermeable. The coating may impregnate the body support substrate 130 to make the cellulose-based material forming the body support substrate 130 fluid impermeable. The degree of impregnation may vary depending on the particular embodiment. For example, the coating may completely impregnate the body support substrate 130, or the coating may impregnate the body support substrate 130 along the subject support surface 132 and the outer surface 133 enough to interlock with the surfaces. In other words, the coating may fully or partially impregnate the body support substrate 130. As described above, the coating may also be used to laminate layers of the cellulose-based material together to form the thickness t of the body support substrate 130.

Although in various embodiments, the coating may be used to impart fluid resistance, it is contemplated that in other embodiments, coatings may be used to provide other advantageous properties. For example, the coating may make the body support substrate 130 antimicrobial by including an agent in the coating that mitigates or prevents microbial growth, or reduce the friction of the surface of the body support substrate 130, such as to aid in sliding the sling 112 between the subject and a surface on which the subject is disposed, such as a bed or chair. In some embodiments, the coating may be used to increase a tensile strength of the body support substrate 130.

In embodiments in which the sling optionally includes handles 114, such as the embodiment shown in FIG. 2A, the handles 114 are configured to help a person, such as a caregiver, move the subject when the subject is supported by the subject support apparatus 100. The handles 114 may include a grip portion and coupling portions that couple the handles 114 to the outer surface 133 of the body support substrate 130. The coupling portions may include staples, stitches, an adhesive, or another attachment mechanism configured to couple the handles 114 to the outer surface 133. In various embodiments, the handles 114 may be formed from a cellulose-based material, such as a paper material which may be the same type of paper material as the body support substrate 130, or another type of paper material. In still other embodiments, the handles 114 may be made from a cotton, vinyl, polyester, nylon, or the like.

The optional binding 116, shown in FIG. 2A, is coupled to the perimeter edge of the sling 112 and forms the upper loops 118 and at least a portion of the leg support loops 120. In various embodiments, the binding 116 may be planar, but may have a C-shaped cross-section when wrapped around the perimeter edge of the sling 112, including an upper portion and a lower portion around the body support substrate 130. In embodiments including the binding 116, the perimeter edge of the sling 112 is positioned between the upper portion and the lower portion of the binding 116 using stitches, staples, glue or adhesive, or other attachment mechanisms. The binding 116 may be made from a cellulose-based material, such as a paper material, a cotton, vinyl, polyester, nylon, or the like.

The upper loops 118 and the leg support loops 120 are configured to be coupled to a sling bar 200 and cooperate therewith to suspend, lift, lower, turn, and/or transport a subject supported by the sling 112. In some embodiments, such as the embodiments shown in FIGS. 1 and 2A, the upper loops 118 extend from the back support portion 122 and the leg support loops 120 extend from the leg support portions 126. The upper loops 118 and/or leg support loops 120 can be configured in any one of a variety of ways to help support subjects of different sizes and to perform different functions.

Although in various embodiments, the upper loops 118 and the leg support loops 120 may be formed from the binding 116, in some embodiments, the upper loops 118 and the leg support loops 120 may be formed independent from the binding 116. Accordingly, in some embodiments, the subject support apparatus 100 may include the binding 116, but not upper loops 118 and/or leg support loops 120. In other embodiments, the subject support apparatus 100 may include the upper loops 118 and/or the leg support loops 120, but not the binding 116. In embodiments in which the sling 112 includes upper loops 118 and/or leg support loops 120 but not a binding 116, the loops may be separately formed and coupled to the sling 112 using stitches, adhesive, stapes, or the like.

The upper loops 118 and/or the leg support loops 120 may be formed from any suitable material, provided they have sufficient strength to support the weight of the subject. For example, in various embodiments, the upper loops 118 and/or the leg support loops 120 may be formed from a woven nylon strap, such as a strap formed from ballistic nylon. However, in various embodiments, the upper loops 118 and/or the leg support loops 120 may be formed from a cellulose-based material, such as a paper material. For example, the upper loops 118 and/or the leg support loops 120 may be formed from multiple layers of paper folded or adhered to one another to form the upper loops 118 and/or the leg support loops 120.

In some embodiments, the subject support apparatus 100 may not include the upper loops 118 and/or the leg support loops 120. For example, the sling 112 shown in FIG. 2B is free of straps sewn to the sling 112 and/or loops for coupling the sling 112 to a lift mechanism 500 (FIG. 5). In such embodiments, clamps may be used to couple the sling 112 to the sling bar 200. For example, clamps may be selectively coupled to the sling 112 along the outer perimeter 202 of the sling 112 to couple the sling 112 to the lift mechanism 500. More particularly, the clamps may be coupled to the lift mechanism 500 by straps selectively coupled to the sling bar 200 which is, in turn, connected to the lift mechanism 500, as will be described in greater detail below. Each strap may include, for example, a ring or loop at one end to couple the strap to the sling bar 200 and may be coupled to a clamp at the other end of the strap. The clamp may be coupled to the sling 112, for example, by engaging the sling 112 with the clamp in a closed position.

The straps coupling the clamps to the lift mechanism 500 may be formed from any suitable material, provided they have sufficient strength to support the weight of the subject. For example, in various embodiments, the straps coupling the clamps to the lift mechanism 500 may be formed from a woven nylon strap, such as a strap formed from ballistic nylon. However, in various embodiments, the straps coupling the clamps to the lift mechanism 500 may be formed from a cellulose-based material, such as a paper material. For example, the straps coupling the clamps to the lift mechanism 500 may be formed from multiple layers of paper folded or adhered to one another to form the strap.

In embodiments in which the sling 112 is coupled to straps using clamps, it is contemplated that areas of the sling 112 intended to engage with the clamps may be reinforced, such as by using additional layers of the cellulose-based material.

In the embodiment depicted in FIG. 1, the subject support apparatus 100 is coupled to a sling bar 200 by looping the upper loops 118 and the leg support loops 120 over hooks of the sling bar 200, as will be described in greater detail below. The subject support apparatus 100 is selectively coupled to the sling bar 200 such that the subject support apparatus 100 is removable from the sling bar 200, and different subject support apparatuses may be coupled to the sling bar 200. In various embodiments, the upper loops 118 and the leg support loops 120 may transfer the weight of the subject up from the subject support apparatus 100 to the sling bar 200 and the lift mechanism 500. Accordingly, the upper loops 118 and the leg support loops 120 can assist in transferring and dispersing the load over a greater area, thereby reducing discomfort that may be experienced by the subject.

The sling bar 200 is coupled to lift mechanism 500 (FIG. 5). In embodiments, the lift mechanism 500 may include a ceiling-mounted lift mechanism, a mobile lift, or the like. Although various embodiments describe the coupling of the sling bar 200 to a lift mechanism 500, it is contemplated that in other embodiments, the sling bar 200 may be coupled to another overhead structure, such as a ceiling, beam, or the like. By coupling the subject support apparatus 100 to the lift mechanism 500 or overhead structure through the sling bar 200, some or all of the bodyweight of the subject 10 may be supported by the overhead structure, which may assist the subject 10 in a variety of activities, including standing and walking. For example, in some configurations the sling bar 200 and the overhead structure may be positioned over a treadmill, and the overhead structure may support some or all of the bodyweight of the subject 10, thereby assisting the subject 10 in walking on the treadmill. Sling bars 200 as well as lift mechanisms are described in greater detail below.

To secure the subject support apparatus 100 around a subject 10, as shown in FIG. 1, the subject support apparatus 100 is placed against the subject 10 with the back support portion 122 across the back of the subject and the leg support portions 126 extending along the legs of the subject 10. For example, the sling 112 may be positioned between the subject 10 and a surface upon which the subject 10 is disposed by sliding the sling 112 beneath the subject 10. In various embodiments, the sling 112 is positioned between the subject 10 and the surface upon which the subject 10 is disposed with the subject support surface 132 in contact with the subject 10 while the outer surface 133 is in contact with the surface upon which the subject 10 is disposed. Each leg support portion 126 is passed between the legs of the subject 10, each leg support portion 126 partially encircling one of the subject's legs. One of the leg support loops 120 is passed through the other leg support loop 120, crossing in front of the subject's torso. The upper loops 118 and the leg support loops 120 may then be coupled to the sling bar 200 and lift mechanism 500 by looping the straps over the hooks 406.

Although specific sling configurations are shown and described herein, it is contemplated that other configurations of slings with cellulosed-based or paper support surfaces may be used. For example, the sling may be in the form of a vest, a wrap, or the like.

### Sling Bars

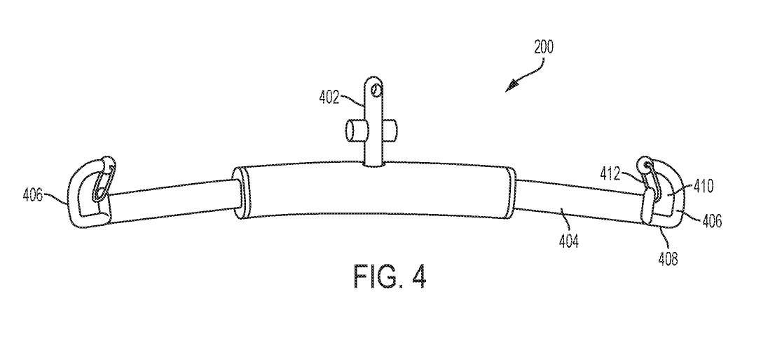

In various embodiments, such as the embodiment depicted in FIG. 1, the subject support apparatus 100 is coupled to an overhead structure, such as a lift mechanism 500, using a sling bar 200. FIG. 4 depicts a sling bar 200 in greater detail.

As shown in FIG. 4, the sling bar 200 includes a connector 402 for coupling the sling bar 200 to an overhead structure, such as a lift mechanism. The connector 402 is fixedly coupled to the sling bar 200 in FIG. 4, although in other embodiments, the connector 402 may be movably coupled to the sling bar 200. Without being bound by theory, allowing the connector 402 to move with respect to the sling bar 200 may help to decrease the torque forces on the connector 402 when a subject support apparatus is coupled to the sling bar 200, maintain the alignment of the subject support apparatus, sling bar, and lift mechanism, and prevent twisting of various components.

The sling bar 200 includes an elongated bar 404 and two hooks 406 coupled to the distal ends of the elongated bar 404. In other embodiments, the sling bar 200 may be an X-shaped sling bar that includes two curved frame members coupled by a middle frame member and including four support apparatus coupling mechanisms. In still other embodiments, the sling bar may include a U-shaped frame including two support apparatus coupling mechanisms and a U-shaped handle extending from the frame to provide stability to a subject being lifted. Other sling bar configurations are contemplated. Various sling bar configurations are described in greater detail in U.S. Patent Application Publication No. 2015/0216753, entitled “Person Lift System”, which is hereby incorporated by reference in its entirety.

The hooks 406 include a coupling base 408 with a recessed space 410 therein and a latch 412 configured to selectively enclose the recessed space 410. The latch 412 is pivotally coupled to the coupling base 408 and is configured to extend across the recessed space 410 in a closed position and rotate towards the recessed space 410 in an open position. In operation, when a user couples a subject support apparatus 100 to the hook 406, the user pushes the latch 412 (i.e., rotates the latch 412 toward the recessed space 410), such as with one of the upper loops 118 and/or one of the leg support loops 120 to allow the strap(s) or other portion of the subject support apparatus 100 to be inserted into the recessed space 410. When a user removes the subject support apparatus 100 from the hook 406, the user pushes the latch 412 to rotate the latch 412 toward an open position (i.e., rotates the latch 412 toward the recessed space 410) and allow the subject support apparatus 100 to be removed from the recessed space 410.

Suitable sling bars include, by way of example and not limitation, those commercially available under the trade names Universal SlingBar, SlingBar Mini, and Sling Cross-Bar, from Liko, HILL-ROM®, or Hill-Rom Services, Inc. (Batesville, Ind.). Additionally, it is contemplated that some embodiments may not include a sling bar, as will be described in greater detail below.

### Overhead Structures

In some embodiments, the overhead structure may be a lift mechanism, such as a mobile lift or, alternatively, an overhead lift mechanism 500 as depicted in FIG. 5. The overhead lift mechanism 500 may include a lift 502, a strap 504 configured to be extended and retracted by the lift 502, and a control system including an input device 506 configured to control operations of the lift 502. In embodiments, the sling bar 200 is coupled to an end of the strap 504 through the connector 402. The lift 502 may further include a motor and a drum (not shown), each positioned within a housing 508. The drum may be coupled to a shaft of the motor and may be configured to extend and retract the strap 504 as the motor rotates the drum in response to a user providing an input to the control system via an input device 506. Various lift assemblies may be employed, including those described in U.S. Patent Application Publication No. 2015/0216753, entitled “Person Lift System”, which is hereby incorporated by reference in its entirety. Suitable commercially available lift assemblies include, by way of example and not limitation, lift systems available under the trade names GOLVO®, LIKO®, SABINA®, VIKING®, UNO™, LIKOGUARD™, LIKORALL™, and MULTIRALL™, from Liko, HILL-ROM®, or Hill-Rom Services, Inc. (Batesville, Ind.).

While the example embodiments are described in use with a sling bar of a lift mechanism 500 mounted to a ceiling, it is understood that the various embodiments described herein could be used with mobile lift units as well. Mobile lift units are stand-alone structures that are configured to roll up next to a bed or chair, attach to a patient, and lift the patient. The sling bar can be attached to a lift arm of the mobile lift unit, which is then raised and lowered. Various mobile lift units can be used in conjunction with these embodiments, such as but not limited to mobile lift units including a Viking-M mobile lift manufactured by Liko of Lulea, Sweden.

Moreover, while a lift mechanism, such as the one shown and described in FIG. 5, may enable vertical lifting of the subject, in some embodiments, such as embodiments in which the subject is capable of standing or walking with support, the overhead structure may provide support rather than vertical lifting. In such embodiments, the overhead structure may be a ceiling. Alternatively or in addition, the overhead structure may be another structure that is stationary in one or both vertical and horizontal directions relative to the ceiling.

Based on the foregoing, it should be understood that various embodiments provide for subject support apparatuses that include slings made from cellulose-based or paper materials. Moreover, various embodiments described herein provide subject support apparatuses that are free of materials such as cotton, vinyl, polyester, nylon, or the like, enabling the subject support apparatuses to be disposable and biodegradable. Such subject support apparatuses may be inexpensive to manufacture, recyclable, and generally ecologically friendly. In embodiments in which the subject support apparatus includes components (e.g., binding, handles, straps, etc.) that are formed from non-cellulose-based, non-recyclable, and/or non-biodegradable materials, it is contemplated that such components may be removed and repurposed while the cellulosed-based sling is disposed and/or recycled. For example, the straps, binding, handles, and the like may be coupled to a new cellulose-based sling for use with a different subject.

Embodiments can be described with reference to the following numbered clauses, with preferred features laid out in the dependent clauses:

1. A sling comprising a body support substrate having a subject support surface on a first side of the body support substrate and an outer surface on a second side of the body support substrate opposite the first side, wherein the subject support surface and the outer surface are separated by a thickness t of the body support substrate, and wherein the body support substrate is formed from a cellulose-based material.

2. A sling comprising a body support substrate having a subject support surface on a first side of the substrate and an outer surface on a second side of the substrate opposite the first side, wherein the subject support surface and the outer surface are separated by a thickness t of the body support substrate, and wherein the body support substrate is formed from a cellulose-based material, and at least two support loops coupled to the sling.

3. The sling of clause 1 or clause 2, wherein at least one of the subject support surface and the outer surface has a coating thereon and wherein the sling is fluid impermeable.

4. The sling of clause 3, wherein the coating comprises a biodegradable polymer.

5. The sling of clause 3 or clause 4, wherein the subject support surface and the outer surface have the coating thereon.

6. The sling of any preceding clause, wherein the cellulose-based material comprises a paper material selected from the group consisting of cellulosic paper, construction paper, kraft paper, art paper, paper board, or coated paper.

7. The sling of any preceding clause, wherein the thickness t of the body support substrate is constant along a length and width of the body support substrate.

8. The sling of any of clauses 1-6, wherein the thickness t varies along at least one of a length or a width of the body support substrate.

9. The sling of clause 8, wherein the sling comprises a back support portion and leg support portions extending from the back support portion, and wherein an area of the body support substrate corresponding to the leg support portions has a thickness greater than an area of the body support substrate corresponding to a perimeter of the back support portion.

10. The sling of clause 8 or clause 9, wherein the sling comprises a back support portion and leg support portions extending from the back support portion, and wherein an area of the body support substrate corresponding to an area of the back support portion that supports the shoulders of the subject has a greater thickness than an area of the body support substrate corresponding to an area of the back support portion supporting a lower back of the subject.

11. The sling of any preceding clause, wherein the sling comprises pleats and/or darts to contour the sling.

12. The sling of any preceding clause, wherein the support loops are formed from a cellulose-based material.

13. A method of lifting a subject comprising positioning a sling between the subject and a surface upon which the subject is disposed, the sling formed from a body support substrate having a subject support surface on a first side of the body support substrate and an outer surface on a second side of the body support substrate opposite the first side, wherein the subject support surface and the outer surface are separated by a thickness t of the body support substrate, and wherein the body support substrate comprises a cellulose-based material, coupling the sling to a lift mechanism, and activating the lift mechanism to lift the subject.

14. The method of clause 13, wherein at least one of the subject support surface and the outer surface has a coating thereon and wherein the sling is fluid impermeable.

15. The method of clause 14, wherein the coating comprises a biodegradable polymer.

16. The method of clause 14 or 15, wherein the subject support surface and the outer surface have the coating thereon.

17. The method of any of clauses 13-16, wherein the cellulose based material comprises a paper material selected from the group consisting of cellulosic paper, construction paper, kraft paper, art paper, paper board, or coated paper.

18. The method of any of clauses 13-17, wherein the thickness t of the body support substrate is constant along a length and width of the body support substrate.

19. The method of any of clauses 13-17, wherein the thickness t varies along at least one of a length or a width of the body support substrate.

20. The method of clause 19, wherein the sling comprises a back support portion and leg support portions extending from the back support portion, and wherein an area of the body support substrate corresponding to the leg support portions has a thickness greater than an area of the body support substrate corresponding to a perimeter of the back support portion.

21. The method of clause 19 or clause 20, wherein the sling comprises a back support portion and leg support portions extending from the back support portion, and wherein an area of the body support substrate corresponding to an area of the back support portion that supports the shoulders of the subject has a greater thickness than an area of the body support substrate corresponding to an area of the back support portion supporting a lower back of the subject.

22. The method of any of clauses 13-21, wherein the sling comprises pleats and/or darts to contour the sling.

23. The method of any of clauses 13-22, wherein the support loops are formed from a cellulose-based material.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A sling comprising:
a body support substrate comprising a subject support surface on a first side of the body support substrate and an outer surface on a second side of the body support substrate opposite the first side, wherein the subject support surface and the outer surface are separated by a thickness t of the body support substrate, and wherein the body support substrate is formed from a cellulose-based material.

2. The sling of claim 1, wherein at least one of the subject support surface and the outer surface has a coating and wherein the sling is fluid impermeable.

3. The sling of claim 2, wherein the coating comprises a biodegradable polymer.

4. The sling of claim 3, wherein the subject support surface and the outer surface have the coating thereon.

5. The sling of claim 1, wherein the cellulose-based material comprises a paper material selected from the group consisting of cellulosic paper, construction paper, kraft paper, art paper, paper board, or coated paper.

6. The sling of claim 1, wherein the thickness t of the body support substrate is constant along a length and width of the body support substrate.

7. The sling of claim 1, wherein the thickness t varies along at least one of a length or a width of the body support substrate.

8. The sling of claim 7, wherein the sling comprises a back support portion and leg support portions extending from the back support portion, and wherein an area of the body support substrate corresponding to the leg support portions has a thickness greater than an area of the body support substrate corresponding to a perimeter of the back support portion.

9. The sling of claim 7, wherein the sling comprises a back support portion and leg support portions extending from the back support portion, and wherein an area of the body support substrate corresponding to an area of the back support portion that supports the shoulders of the subject has a greater thickness than an area of the body support substrate corresponding to an area of the back support portion supporting a lower back of the subject.

10. A sling comprising:
body support substrate having a subject support surface on a first side of the substrate and an outer surface on a second side of the substrate opposite the first side, wherein the subject support surface and the outer surface are separated by a thickness t of the body support substrate, and wherein the body support substrate is formed from a cellulose-based material; and
at least two support loops coupled to the body support substrate.

11. The sling of claim 10, wherein at least one of the subject support surface and the outer surface has a coating thereon and wherein the sling is fluid impermeable.

12. The sling of claim 11, wherein the coating comprises a biodegradable polymer.

13. The sling of claim 12, wherein the subject support surface and the outer surface have the coating thereon.

14. The sling of claim 10, wherein the cellulose-based material comprises a paper material selected from the group consisting of cellulosic paper, construction paper, kraft paper, art paper, paper board, or coated paper.

15. The sling of claim 10, wherein the sling comprises pleats and/or darts to contour the sling.

16. The sling of claim 10, wherein the support loops are formed from a cellulose-based material.

17. A method of lifting a subject comprising:
positioning a sling between the subject and a surface upon which the subject is disposed, the sling formed from a body support substrate having a subject support surface on a first side of the body support substrate and an outer surface on a second side of the body support substrate opposite the first side, wherein the subject support surface and the outer surface are separated by a thickness t of the body support substrate, and wherein the body support substrate comprises a cellulose-based material;
coupling the sling to a lift mechanism; and
activating the lift mechanism to lift the subject.

18. The method of claim 17, wherein the thickness t varies along at least one of a length or a width of the body support substrate.

19. The method of claim 17, wherein the cellulose-based material comprises a paper material selected from the group consisting of cellulosic paper, construction paper, kraft paper, art paper, paper board, or coated paper.

20. The method of claim 17, wherein at least one of the subject support surface and the outer surface has a coating thereon and wherein the sling is fluid impermeable.
